(19) United States
(12) Patent Application Publication
(10) Pub. No.: US 2015/0141045 A1
(43) Pub. Date: May 21, 2015

(54) GEOFENCE

(71) Applicants: Weigen Qiu, Calgary (CA); John Baker, Southlake, TX (US)

(72) Inventors: Weigen Qiu, Calgary (CA); John Baker, Southlake, TX (US)

(73) Assignee: TELECOMMUNICATION SYSTEMS, INC., Annapolis, MD (US)

(21) Appl. No.: 14/547,886

(22) Filed: Nov. 19, 2014

Related U.S. Application Data
(60) Provisional application No. 61/907,311, filed on Nov. 21, 2013.

(51) Int. Cl. H04W 4/02; H04W 64/00; H04W 8/00

(52) U.S. Cl. CPC H04W 4/021; H04W 8/005; H04W 64/006
USPC 455/456.1

(57) ABSTRACT

A mobile device can include an application configured to set an update interval for location information characterizing a location of the mobile device based on a current location of the mobile device and a location of a wireless device has an associated geofence. The update interval can define an interval of time between queries for the location information.

### CROSS-REFERENCE TO RELATED APPLICATION

This application claims the benefit of priority to U.S. Provisional Application No. 61/907311, filed on Nov. 21, 2013, and entitled GEOFENCE ENHANCEMENT WITH Wi-Fi AND BLUETOOTH SSIDs, the entirety of which is herein incorporated by reference.

### TECHNICAL FIELD

This disclosure relates to wireless communications and in particular to communications with a wireless device that has an associated a geofence.

### BACKGROUND

Location enabling technology is implemented in a vast majority of today's handheld mobile devices as a result of mandates requiring wireless devices to incorporate location technology, in the event users of wireless devices need to be located throughout use of emergency services (e.g., 911). Location enabling technologies can be generally implemented in mobile devices include tracking technologies capable of delivering approximate location of a wireless device, such as a satellite-enabled Global Positioning System (GPS), cell tower positioning, network access points, etc. This incorporation of location enabling technology in mobile devices has consequently led to a growing emergence of location based services (LBS). A location based service (LBS) obtains a geographic location of a wireless device and provides services accordingly.

A geofence is a virtual perimeter for a real-world geographic area. A geofence can be dynamically generated, such as in a radius around a retail facility (e.g., a store) or point location. Alternatively, a geo-fence can be a predefined set of boundaries, such as school attendance zones and/or neighborhood boundaries.

### SUMMARY

One example relates to a mobile device that can include a memory configured to store machine readable instructions and a processing unit configured to access the memory and execute the machine readable instructions. The machine readable instructions can include an application configured to set an update interval for location information characterizing a location of the mobile device based on a current location of the mobile device and a location of a wireless device that has an associated geofence. The update interval can define an interval of time between queries for the location information.

Another example relates to a non-transitory machine readable medium having machine executable instructions. The machine executable instructions can include an application configured to determine an update interval that defines an interval of time between queries to a location sensor for updated location information and an interval of time between requests for scans for wireless devices at a wireless interface. The determination can be based on a velocity vector of a mobile device and a distance between the mobile device and a location of a wireless device that has an associated geofence.

Yet another example relates to a method that can include setting an update interval that defines an interval of time between queries to a location sensor for updated location information and an interval of time between requests for scans for wireless devices at mobile device. The update interval can be based on a velocity vector of the mobile device and a distance between the mobile device and a location of a wireless device that has an associated geofence. The method can also include initiating a geofence entry event for a geofence in response to identifying a detected wireless device. The method can further include providing an identifier of the wireless device to an enterprise server in response to the initiating.

### BRIEF DESCRIPTION OF THE DRAWINGS

FIG. 1 illustrates an example of a system for tracking a location of a mobile device relative to a geofence.

FIG. 2 illustrates a mobile device that can track its location relative to the location of a geofence.

FIG. 3 illustrates a detailed view of an interval calculator.

FIG. 4 illustrates an example of a method for tracking a location of a mobile device relative to a geofence.

### DETAILED DESCRIPTION

This disclosure is related to a mobile device that can intelligently track the position (location) of the mobile device relative to a location of a particular geofence. The boundary of the particular geofence can correspond to a transmission range of a wireless device located in the geofence. The mobile device can be configured to control an update interval of location information derived from satellite signals and/or carrier signals based on the distance between the mobile device and the location of the particular geofence. Control of the update interval can extend battery life of the mobile device. Moreover, setting the boundary of the geofence to the transmission range of the wireless device increases precision of the boundary as compared to other location tracking mechanisms.

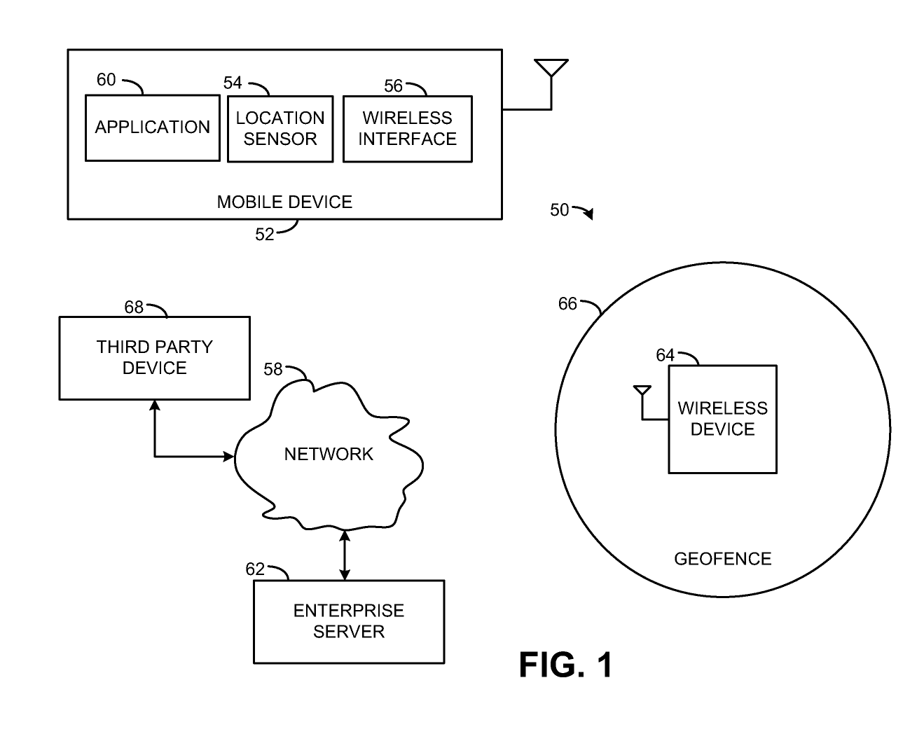

FIG. 1 illustrates an example of a system 50 for tracking a location of a mobile device 52 relative to a geofence. The mobile device 52 could be implemented, for example, as an end-user device, such as a smart phone, a feature phone, a wearable technology device (e.g., a smartwatch), a tablet computer, etc. The mobile device 52 can include a location sensor 54 that can determine location information for the mobile device 52. The location information can include a geographic location (e.g., latitude and longitude coordinates) for the mobile device 52 based on received signals. The location information can also include several recorded positions of the mobile device 52 over a time period. In some examples, the received signals can be satellite signals, such as signals from a Global Navigation Satellite System (GNSS) satellite, such as a Global Positioning System (GPS) satellite, a GLONASS satellite, etc. Additionally or alternatively, the location sensor 54 can be configured to triangulate signals received from cell towers to determine the location information.

The mobile device 52 can also include a wireless interface 56 that can communicate with wireless devices using standard communication protocols, such as a standard wireless carrier protocol, Wi-Fi and/or Bluetooth. The wireless interface 56 can also be employed to connect the mobile device 52 to a network 58. The network 58 could be implemented, for example, as a private network (e.g., a wireless carrier network), a public network (e.g., the Internet) or a combination thereof.

The mobile device 52 can include an application 60 (e.g., application software) executing thereon. In some examples, the application 60 can be, for example, a client application that can communicate with an enterprise server 62 via the network 58. In other examples, the application 60 can be a standalone application. The application 60 can include a geofence table with a list of wireless identifiers (IDs), and an associated location. In some examples the table can be provided (and updated) to application 60 from the enterprise server 62. Table 1 illustrates an example of the geofence table that could be employed by the application 60.

TABLE 1

| WIRELESS ID | LOCATION |
|---|---|
| ID1 | LOCATION INFORMATION 1 |
| . . . | |
| IDN | LOCATION INFORMATION 1 |

In Table 1, there are N number of wireless IDs (ID1-IDN) for N number of wireless devices (e.g., wireless beacons) with N number of corresponding instances of location information, where N is an integer greater than or equal to one. Each wireless ID can be implemented, for example, as a Service Set Identification (SSID) or a Basic Service Set Identifier (BSSID) received via the Wi-Fi protocol, or the Bluetooth protocol, etc. The BSSID could be implemented as a media access control (MAC) address of the corresponding wireless device. Each instance of location information can include, for example, longitude and latitude coordinates of the corresponding wireless device. In other examples, other data structures (e.g., a database) could additionally or alternatively be employed.

Each wireless device can be, for example, a Wi-Fi hotspot (e.g., a Wi-Fi router), a Bluetooth device, etc. Each wireless device can have an associated geofence. In FIG. 1, a single wireless device 64 is illustrated. The wireless device 64 can have a geofence defined by the boundary 66. The boundary 66 of the geofence can correspond to an area in which the wireless device 64 can be detected by other wireless devices, including the mobile device 52 (e.g., a transmission range of the wireless device 64). The boundary 66 of the geofence can vary, for example based on the output power of the wireless device 64 and/or the protocol employed by the wireless device 64. For instance, a Bluetooth device that transmits with a power of 1 milliwatt (mW) would have a smaller area covered by the geofence than a Wi-Fi hotspot with an output power of 50 mW. Additionally, it is noted that a single wireless ID can correspond to an array of physical wireless devices that share a common wireless ID and operate in network to form a geofence.

The application 60 can be configured to monitor the location information provided by the location sensor 54 to determine a (coarse) location of the mobile device 52. The location of the mobile device 52 can be compared against the location included in the location information of each entry in the geofence table. The application 60 can select a wireless device 64 (a selected device) that is nearest to the mobile device 52. Alternatively, the selected device may not be the closest device. Instead, in some examples, the selected device can be chosen manually (e.g., in response to user input). The application 60 can employ an adaptive algorithm to determine a time interval between queries for updates to the location information and a time interval between providing request to the wireless interface 56 to scan for wireless devices. Such time intervals (that may be different) can collectively be referred to as an update interval.

As one example, the application 60 can input the location information (including several recorded positions of the mobile device 52), along with the current velocity vector (speed and heading) of the mobile device 52, estimated by an adaptive algorithm (e.g., a Kalman Filter), and the location of the selected device into the adaptive algorithm to determine the update interval.

In some other examples, such as examples where the mobile device 52 is substantially stationary, a Least Squares Algorithm can be employed to implement the adaptive geofence algorithm. The least squares geofence algorithm can employ statistical techniques to estimate a geographic location of the mobile device 52 based on several sample location points (included in the location information). More particularly, the least squares geofence algorithm can employ a conventional weighted least squares model to compute a weighted best estimate of a geographic position of a the mobile device 52. The “best estimate” of the geographic position of the mobile device 52 can be employed to determine the distance between mobile device 52 and the selected device 64, such that the update interval can be determined.

The update interval can be change each time the location information has been updated and/or each time that a scan of wireless devices has been executed. For instance, in a situation where the location information of the mobile device 52 indicates that the location of the mobile device 52 is relatively far away from the location of the selected device (e.g., 5 miles or more), the update interval can be set to a relatively long time period (e.g., 5 minutes). In contrast, in a situation where the location information indicates that the mobile device 52 is relatively close to the location of the selected device (e.g., 0.5 miles or less), the update interval can be set to a relatively short time period (e.g., 30 seconds or less). By adjusting the update interval, operations that require a relatively large amount of power (e.g., updating the location information and scanning for wireless devices) can be performed at a lower frequency (in certain situations), thereby conserving battery life (an amount of time a device can operate on a single charge of a rechargeable battery) of the mobile device 52.

At some point, the mobile device 52 can enter into the area circumscribed by the boundary 66 defined by the geofence of the wireless device 64. Upon crossing into the boundary 66 defined by the geofence, and upon the wireless interface 56 scanning for wireless devices, the wireless device 64 can be detected. Detection of the wireless device 64 can include, for example, receiving a wireless ID for the wireless device 64. Upon receipt of the wireless device 64, the application 60 can match the wireless ID of the wireless device 64 with an ID in the geofence table. Upon matching the wireless ID of the wireless device 64 with the ID in the geofence table, the mobile device 52 can initiate a geofence entry event, which can indicate that the mobile device 52 has crossed the boundary 66 defining the geofence. It is noted that by implementing the geofence with a wireless device, detection of the wireless device 64 can ensure (with a high degree of accuracy) that the mobile device 52 is in fact within the boundary 66 of the geofence as compared to conventional techniques (e.g., location tracking based on satellite signals) that have relatively large margins of error. The geofence entry event can include the application 60 providing the enterprise server 62 the wireless ID of the wireless device 64, and indicating that the mobile device 52 has entered the geofence corresponding to the wireless device 64.

The enterprise server 62 can analyze the wireless ID of the device to determine a location of the mobile device 52. For instance, in some examples, the geofence can define a boundary 66 (or a proximity) of a retail establishment. In such a situation, the enterprise server 62 can provide a message (e.g., a notification) to the mobile device 52. In some examples, the message can be a push notification that can be output at a display of the mobile device 52. In other examples, the message can be a short message (e.g., a text message, such as a short message service (SMS) message). In some instances, content of the message can include, for example, an advertisement, such as a coupon. For instance, in a situation where the retail establishment corresponding to the wireless device 64 is a coffee shop, the content of the message could include an advertisement for a discount on a coffee. Accordingly, by employing this system 50, targeted and timely advertisements can be provided to perspective customers.

In other examples, the wireless device 64 could define the boundaries of a facility, such as a school. In this situation, upon the enterprise server 62 receiving an indication that the mobile device 52 is communication with the wireless device 64 of the facility, the enterprise server 62 can be configured to provide (e.g., push) a message to a third party device 68. The third party device 68 could be a pre-registered device (e.g., another mobile device 52, a desktop computer, a laptop computer, etc.) that is registered to receive a notification when the mobile device 52 enters the boundary 66 of the geofence. For instance, in the situation where the facility is a school, the user of the third party device 68 could be a parent of a user of the mobile device 52. In this manner, the enterprise server 62 can provide the third party device 68 with a notification that the mobile device 52 (and the user of the mobile device 52) has arrived at the facility (e.g., the school).

In some examples, the adaptive geofence algorithm can be configured to update the update interval in response to detecting the wireless device 64. For instance, in situations where the wireless device 64 is implemented in a retail facility, a school or other indoor facility, the update interval of the location sensor 54 can be increased (e.g., to an interval of 5 minutes or more) since the location of the mobile device 52 is known (e.g., the mobile device 52 is within the boundary 66 of the geofence and some signals (e.g., satellite signals) are impeded indoors.

Upon the mobile device 52 exiting the boundary 66 of the geofence, communications between the mobile device 52 and the wireless device 64 would be lost. Thus, in response to the mobile device 52 losing communication with the wireless device 64, the application 60 can initiate a geofence exit event. The geofence exit event can include sending the enterprise server 62 an indication that the mobile device 52 is no longer communicating with the wireless device 64. In some examples, the enterprise server 62 can respond by providing another message to the application 60. In some examples, the notification can be another advertisement (e.g., another coupon, a thank you message, etc.). In other examples, such as situations where the geofence corresponds to a boundary 66 of a school, the enterprise server 62 can provide a notification to the third party device 68 that the mobile device 52 has exited the geofence (e.g., the school). Additionally, upon losing communication with the geofence, the adaptive geofence algorithm can update the update interval in the manner described.

By employing the system 50, battery power of the mobile device 52 can be conserved by reducing the number of times that the location of the mobile device 52 is measured and/or the number of times the wireless interface 56 scans for other wireless devices. Additionally, there is no need for the mobile device 52 to provide the location information for the mobile device 52 to the enterprise server 62 (or any other external system), thereby avoiding privacy violations of the user of the mobile device 52.

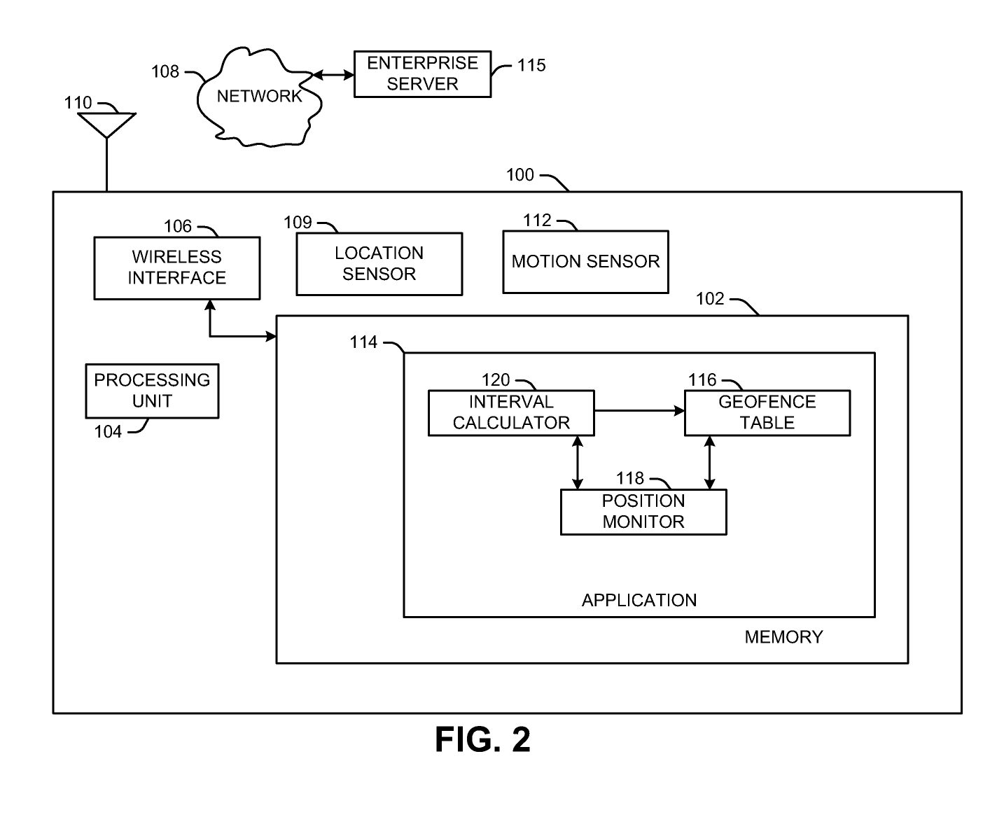

FIG. 2 illustrates an example of a mobile device 100 that can track its location relative to a geofence. The mobile device 100 could be employed, for example, as the mobile device 52 of FIG. 1. The mobile device 100 could be implemented, for example, as an end-user device, such as a smart phone, a feature phone, a wearable technology device (e.g., a smartwatch), a tablet computer, etc. The mobile device 100 can include a memory 102 to store data and machine readable instructions. The memory 102 can be implemented, for example, as a non-transitory machine readable medium. In some examples, the memory 102 can include volatile memory (e.g., random access memory) and/or nonvolatile memory, such as flash memory, a solid state drive a hard disk drive or a combination thereof. The mobile device 100 can also include a processing unit 104 configured to access the memory 102 and execute the machine readable instructions. The processing unit 104 can include one or more processor cores.

The mobile device 100 can include a wireless interface 106 that can communicate with a network 108 via an antenna 110. The wireless interface 106 can communicate via a standard wireless communication protocol, such as a protocol of a carrier network, Wi-Fi, Bluetooth, etc. The network 108 could be representative of a carrier network, such as a Long Term Evolution (LTE) network, a 4th Generation (4G) network, a 3rd Generation Partnership Project (3GPP), a 3rd Generation (3G) network, etc. Additionally or alternatively, the network 108 can be representative of a public network, such as the Internet.

The mobile device 100 can further include a location sensor 109. The location sensor 109 can be configured to determine location information for the mobile device 100. The location information can be implemented as longitude and latitude coordinates of the mobile device 100. In some examples, the location information can be based on received radio frequency (RF) signals that are transmitted from satellites (e.g., GNSS satellites). In other examples, the location information can be based on a triangulation of RF signals received from cell towers at the antenna 110.

In some examples, the mobile device 100 can include a motion sensor 112, such as an accelerometer. The motion sensor 112 can provide motion data (e.g., acceleration data) that can be employed to calculate a velocity vector (speed and heading) of the mobile device.

The memory 102 can include an application 114, such as a location application that be employed to track (e.g., monitor) the location of the mobile device 100 relative to a geofence. The application 114 can, in some examples, be a client application that can communicate with an enterprise server 115 via the network 108. In other examples, the application 114 can be a standalone application, and operations of the enterprise server 115 can be implemented by the application 114. The application 114 can include a geofence table 116 (or other data structure) that can include a list of wireless IDs, and associated locations. The geofence table 116 can be implemented in a manner similar to Table 1 explained and described with respect to FIG. 1. In particular, the geofence table 116 can include M number of entries, and each entry can have a wireless ID (e.g. an SSID, a Bluetooth ID, etc.) of a wireless device and associated location information (e.g., latitude and longitude coordinates) of the wireless device. In some examples, the geofence table 116 can be provided (and/or updated) by an external system, such as the enterprise server 115. In other examples, the geofence table 116 can be generated and/or updated locally.

The application 114 can include a position monitor 118 that can provide a request to the wireless interface 106 to scan for other wireless devices. The other wireless devices could be for example, a Wi-Fi device (e.g., Wi-Fi hotspots), a Bluetooth device, etc. Detection of a wireless device can include a wireless ID (e.g., an SSID or a Bluetooth ID) of the detected wireless device. The wireless ID of the detected wireless device can be compared against each of the wireless IDs in the geofence table 116. If no match is found, the position monitor 118 can periodically query the location sensor 109 for updated location information. In response to the query, the location sensor 109 can provide the updated location information.

The updated location information can characterize a current location (e.g., latitude and longitude coordinates) that has been updated at (or near) a time of the query by the position monitor 118. The position monitor 118 can parse the geofence table 116 and select a wireless device with a location (e.g., corresponding to a geofence) that is nearest to the current location of the mobile device 100, which wireless device can be referred to as the selected device. Alternatively, the selected device may not be the nearest device. In such a situation, the selected device can be chosen manually (e.g., in response to user input) or by other methods. The position monitor 118 can also provide the location information (including several recorded points of location of the mobile device 100 over time) of the mobile device 100 as well as the location information of the selected device to an interval calculator 120. Additionally, in other examples, the interval calculator 120 can query the motion sensor 112 for the motion information of the mobile device 100, and the interval calculator 120 can determine a velocity vector (a speed and heading) of the mobile device 100 based on the motion information (e.g., acceleration data).

The interval calculator 120 can include an adaptive algorithm (Kalman Filter or other algorithm) that can be configured to intelligently determine an update interval for the position monitor 118. The update interval can define a time period (e.g., interval) between queries to the location senor 109 for the updated location information and/or the time period (e.g., interval) between requests to the wireless interface 106 to scan for wireless devices. It is noted that in some examples, the interval for querying the location sensor 109 can be different than the interval for requesting the scan for the wireless devices, and the term “update interval” can refer to both intervals. As explained herein, the update interval can be based, for example, on the location of the mobile device 100 relative to the location of the selected wireless device and (in some examples), a (estimated) velocity vector of the mobile device 100.

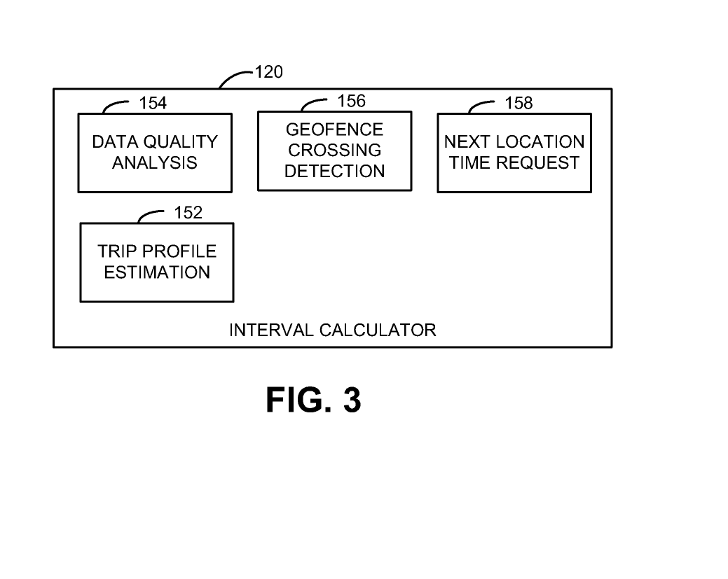

FIG. 3 illustrates a detailed view of the interval calculator. In FIG. 3, the location information provided to the interval calculator can be employed as estimated position parameters (e.g., position estimates) that can be used for raw sensor data blunder detection and geofence crossing determinations in the adaptive algorithm geofence method. Moreover, the estimated velocity vector (speed and heading) parameters can be employed by a trip profile estimation module 152 of the interval calculator 120 to determine dynamic trip profile estimation for the mobile device 100. The dynamic trip profile estimation can be used to refine the estimated positions by restricting a maximum value (e.g., maximum speed) used to generate parameter estimations for the mobile device 100. Furthermore, the estimated velocity vector parameters can be used for geofencing and for a trip profile, and additionally optimize battery consumption on the mobile device.

The interval calculator 120 can include a data quality analysis module 154 that can analyze a position estimate output from the position monitor 118 to statistically determine quality of location data retrieved for the mobile device 100. The data quality analysis module 154 can additionally employ the position estimates provided by the position monitor 118 to detect location blunders in location data retrieved for the mobile device 100.

The interval calculator 120 can employ a geofence crossing detection module 156 that can use a position estimate provided by the position monitor 118 to determine if the mobile device 100 is likely to have crossed a geofence boundary of the selected wireless device, represented as a confidence value. For a given confidence level, (likelihood) of crossing the geofence boundary, the adaptive geofence method can dynamically determine a number of location fixes (e.g., location updates) needed to refine an initial geofence boundary crossing judgment (e.g., initial geofence side condition). In particular, the adaptive geofence algorithm can dynamically determine the quantity of location fixes (location updates) needed to refine an initial judgment of a geofence boundary crossing for the mobile device 100 based on the uncertainty of a position estimate computed for the mobile device 100. For instance, if the mobile device 100 is located in an area where only a cellular network location determination is available, a dynamic number of location fixes reduces the probability of missed boundary crossing alerts for that particular target device. Furthermore, in situations where the mobile device 100 is located in an area where satellite (e.g., GPS) signals are available, a dynamic number of location fixes can reduce the number of location fixes performed for that target device, thereby conserving the device's energy.

The interval calculator 120 can include a next location time request module 158 that can dynamically determine the update interval, which is implemented time intervals between location fixes (e.g., intervals of time between queries for the location data and/or or intervals of time between requests for scans for wireless devices) implemented in the adaptive algorithm geofence method. In particular, the next location time request module 158 can utilize the velocity vector (speed and heading) estimations to dynamically determine an appropriate time interval to implement prior to querying the location sensor 109 for updated location information (e.g., a location fix) and/or sending a request to the wireless interface 106 to scan for wireless devices. For instance, if 30 the mobile device 100 is departing in a direction opposite a geofence boundary (corresponding to the location of the wireless device), the next location time request module 158 can increase the update interval to conserve battery life on the mobile device 100.

Additionally or alternatively, if the mobile device 100 departs in a direction opposite a geofence boundary of the selected wireless device, the next location time request module 158 may select a more energy efficient location fix (e.g., a cellular network location fix instead of a satellite (GPS) location fix) for the mobile device 100, rather than (or in addition to) increasing the update interval, so long as location uncertainty does not impact a geofence boundary crossing confidence level.

The trip profile estimation module 152 can analyze a historical velocity vector (e.g., speed and heading) parameter estimates to establish a trip profile model for the mobile device 100. The trip profile information can be employed as feedback to the position monitor 118 and/or the data quality analysis module 154 to further refine dynamic parameters (e.g., the location information) for the mobile device 100. For instance, trip profile information may be used to implement a constrained state adaptive algorithm (e.g. Kalman filter) estimation.

As a further example of the operation of the interval calculator 120, if the location of the selected wireless device (included in the geofence table 116) is sufficiently far away (e.g., 5 kilometers (km) or more or about 3 miles or more)), the interval calculator 120 can be configured to set the update interval to a relatively long interval time (e.g., 3 or more minutes). In other examples, if the location of the selected wireless device (included in the geofence table 116) is sufficiently close (e.g., 500 meters or less (e.g. about 1640 feet or less)), the interval calculator 120 can be configured to set the update interval to a relatively short interval time (e.g., 30 seconds or less).

Additionally, the update interval calculated by the interval calculator 120 can vary based on the velocity vector of the mobile device 100. For instance, in the situation where the mobile device 100 is relatively far away (e.g., 5 km or more) from the selected device, but the velocity vector of the mobile device 100 is relatively large (e.g., 50 or more kilometers per hour (km/h)) the update interval can be set to a shorter interval (1 minute) than in situations where the velocity vector of the mobile device 100 is relatively small (e.g., 10 km/h or less). Additionally, in situations where the mobile device 100 is relatively close to the selected device (e.g., less than about 1 kilometer) but the velocity vector of the mobile device 100 is relatively small (e.g., 5 km/h or less), the update interval can be set to a longer interval (1 minute or more) than in situations where the velocity vector of the mobile device 100 is greater (e.g., 5 km/h or more). Conversely, in situations where the velocity vector of the mobile device 100 is below a certain threshold, which threshold can indicate that the mobile device 100 is substantially stationary (e.g., less than 1 km/h), the update interval can also be set to a longer interval (e.g., about 3 minutes or more).

The position monitor 118 can be configured to request an interval update time each time the position monitor 118 queries the location sensor 109 for the update location information and/or each time the position monitor 118 requests a scan for wireless devices or some subset thereof. By adjusting the update interval time in the manner described, a total number of times that the location sensor 109 determines the updated location information can be reduced and/or a total number of times that the wireless interface 106 scans for wireless devices can also be reduced, thereby reducing the power consumed by the mobile device 100, thus extending battery life of the mobile device 100.

Upon detecting a wireless device with a wireless ID that is identified in the geofence table 116 (e.g., a wireless device), the position monitor 118 can initiate a geofence entry event. The geofence entry event can include providing the detected wireless ID to the enterprise server 115 via the wireless interface 106. The wireless ID of the detected wireless device, along with a boundary of a geofence can be registered with the enterprise server 115. Accordingly, the enterprise server 115 can determine that the mobile device 100 has crossed the boundary of the geofence corresponding to the detected wireless device.

In some examples, the boundary of the geofence can correspond to a location of a retail facility. In such a situation, upon determining that the mobile device 100 has crossed the boundary of the geofence, the enterprise server 115 can provide a message, such as a push notification or a short message (e.g., an SMS message) to the mobile device 100. In response, the position monitor 118 can be configured to output the content of the message to a user of the mobile device 100. The content of the message can be, for example, an advertisement, a coupon, etc.

In other examples, the boundary of the geofence could correspond to a facility, such as a school. In such a situation, upon the enterprise server 115 determining that the mobile device 100 has cross the boundary of the geofence, the enterprise server 115 can provide a third party device (e.g., the third party device 62 of FIG. 1) with a message (e.g., a short message, a push message, etc.) that indicates that the mobile device 100 has crossed the boundary of the geofence. For instance, in situations where the boundary of the geofence corresponds to the boundary of a school, the message to the third party can indicate that the mobile device 100 (and a corresponding user) has arrived at the school. In this manner the mobile device 100 can be employed to facilitate person (e.g., family) tracking.

During a time period where the wireless device is detected, the position monitor 118 can request an update to the update interval from the interval calculator 120. In some situations, the interval calculator 120 can set the update interval for the querying for the location information to a given interval (e.g., 3 minutes or more) and the update interval for requesting a scan for wireless devices to another interval (e.g., 30 seconds).

In situations where communication with the wireless device is lost (e.g., disconnected), the position monitor 118 can provide the enterprise server 115 with an indication that the connection between the (previously) detected wireless device has ceased (e.g., disconnected). In response, the position monitor 118 can initiate a geofence exit event, which geofence exit event indicates that the mobile device 100 is outside the boundary defined by the geofence to the enterprise server 115. The position monitor 118 can provide an indication of the exiting of the geofence. In some examples, such as situations where the boundary of the geofence corresponds to a retail establishment, upon receiving an indication of the geofence exit event, the enterprise server 115 can be configured to provide the position monitor 118 of the mobile device 100 with another message (e.g., another push notification or another short message). The position monitor 118 can output the content of the other message to the user of the mobile device 100. In some examples, the content of the other message could be another advertisement and/or coupon (such as an enticement to for the user of the mobile device 100 to return to the retail facility), a thank you note, etc.

In examples where the boundary of the geofence corresponds to a facility such as a school, the enterprise server 115 can be configured to provide another message to the third party device indicating that the mobile device 100 (and the user of the mobile device 100) has left the facility. For instance, in situations where the boundary of the geofence corresponds to the boundary of a school, the other message to the third party device can indicate that the mobile device 100 (and a corresponding user) has left the school.

Further, upon determining that the communication with the (previously) detected wireless device has been lost, the position monitor 118 can query the location sensor 109 for the updated location information and/or request the wireless interface 106 to scan for wireless devices. Additionally, the position monitor 118 can provide a request to the interval calculator 120 for a new update interval in the manner described herein.

By employing the mobile device 100, the battery life of the mobile device 100 can be extended since the total number of times that the location sensor 109 updates the location information and/or the total number of times the wireless device scans for other wireless devices can be reduced. Additionally, the mobile device 100 and the enterprise server 115 can determine, with a relatively high degree of accuracy, the location of the mobile device 100 in situations where the mobile device 100 is within a geofence boundary identified in the geofence table 116 without the mobile device 100 outputting the location information to an external system (including the enterprise server 115). In this manner, the privacy of the user of the mobile device 100 can be respected. Still further, since the boundary of the geofence corresponds to detection a wireless device, inherent inaccuracies of the location characterized in the location information can be avoided.

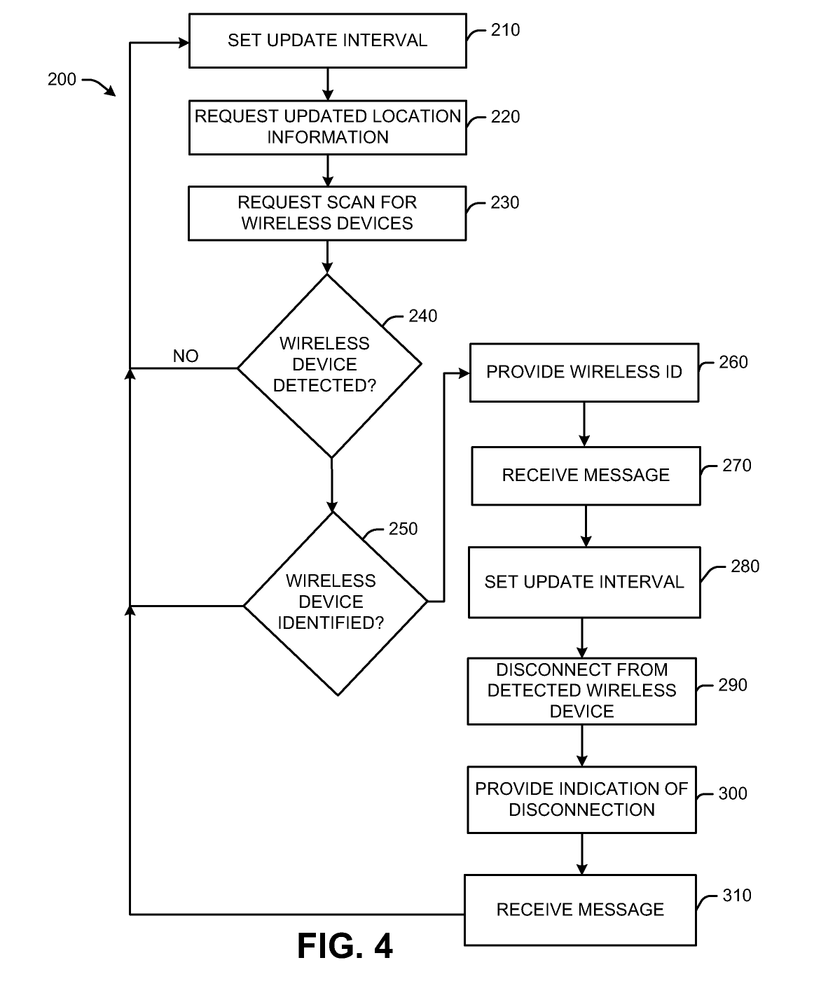

In view of the foregoing structural and functional features described above, example methods will be better appreciated with reference to FIG. 4. While, for purposes of simplicity of explanation, the example methods of FIG. 4 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example methods of FIG. 4 can be implemented as instructions stored in a non-transitory machine-readable medium. The instructions can be accessed by a processing resource (e.g., one or more processor cores) and executed to perform the methods disclosed herein.

FIG. 4 illustrates an example flowchart of a method 200 for tracking a location of a mobile device relative to a geofence. The method can be implemented, for example, by the system 50 of FIG. 1 and/or the mobile device 100 of FIG. 2. At 210, an update interval can be set by an interval calculator (e.g., the interval calculator 120 of FIG. 2) of the mobile device. The update interval can define a time interval (e.g., period of time) between queries to a location sensor (e.g., the location sensor 109 of FIG. 2) for location information that characterizes a geographic location of the mobile device (e.g., longitude and latitude coordinates). Additionally or alternatively, the update interval (or a different update interval) can define a time interval (period of time) between requests to scan at a wireless interface (e.g., the wireless interface 106 of FIG. 2) for wireless devices.

The update interval can be based for example, on a current distance between the mobile device and a selected device (e.g., a nearest wireless device) and a velocity vector of the mobile device. In some examples, the interval calculator can employ an adaptive algorithm (e.g., a Kalman filter) to determine the update interval.

At 220, updated location information can be requested by a position monitor (e.g., the position monitor 118 of FIG. 2). The request can be provided to the location sensor. In response, the location sensor can measure a current location of the mobile device and provide the updated location information to the application. At 230, the position monitor can request that the wireless interface scan for wireless devices.

At 240, a determination by the application can be made as to whether a wireless device has been detected. If the determination at 240 is negative (e.g., NO), the method can return to 210. If the determination is positive (e.g., YES), the method can proceed to 250. At 250, a determination can be made by the application as to whether the detected wireless device can be identified by the application. To identify the detected wireless device, a wireless ID of the detected wireless device (e.g., an SSID or a Bluetooth ID) can be compared against wireless IDs included in a geofence table (e.g., the geofence table 116 of FIG. 2). If the determination at 250 is negative (e.g., NO), the method can return to 210. If the determination at 250 is positive (e.g., YES), the method can proceed to 260.

At 260, the position monitor can provide the wireless ID of the detected wireless device to an enterprise server (e.g., the enterprise server 62 of FIG. 1 and/or the enterprise server 115 of FIG. 2). At 270, a message from the enterprise server corresponding to the detection of the wireless device (e.g., an entry into a geofence) can be received by the position monitor. The message could be, for example, an advertisement for a retail establishment within bounds of the geofence corresponding to the detected wireless device. At 280, the update interval can be set by the update calculator.

At 290, the connection between the mobile device and the detected wireless device can be disconnected. At 300, an indication of the disconnection can be provided to the enterprise server. At 310, a message corresponding to the disconnection (e.g., exiting the geofence) can be received from the enterprise server, and the method 200 can return to 210.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A mobile device comprising:
a memory configured to store machine readable instructions; and
a processing unit configured to access the memory and execute the machine readable instructions, the machine readable instructions comprising:
an application configured to set an update interval for location information characterizing a location of the mobile device based on a current location of the mobile device and a location of a wireless device that has an associated geofence, wherein the update interval defines an interval of time between queries for the location information.

2. The mobile device of claim 1, further comprising:
a location sensor configured to:
receive radio frequency (RF) signals from a plurality of satellites; and
determine the location information based on the received satellite signals in response to a query for the location information.

3. The mobile device of claim 1, wherein the update interval is further based on a velocity vector of the mobile device.

4. The mobile device of claim 3, wherein the application comprises an interval calculator that employs an adaptive algorithm to set the update interval.

5. The mobile device of claim 1, wherein the update interval further defines an interval of time between requests for scans of wireless devices.

6. The mobile device of claim 5, further comprising a wireless interface to scan for wireless devices in response to a request.

7. The mobile device of claim 6, wherein the application is further configured to determine whether an identifier (ID) of a detected wireless device is included in a geofence table.

8. The mobile device claim 7, wherein ID of the wireless device is one of a service set identifier (SSID) that is received via the Wi-Fi protocol or the Bluetooth protocol.

9. The mobile device of claim 7, wherein the application is further configured to initiate a geofence entry event for a boundary of a geofence in response to determining that the wireless ID of the detected wireless device is included in the geofence table.

10. The mobile device of claim 9, wherein the geofence entry event comprises providing the wireless ID of the detected wireless device to an enterprise server.

11. The mobile device of claim 9, wherein the application is configured to:
receive a message from the enterprise server in response to the providing; and
output content of the message.

12. The mobile device of claim 9, wherein the enterprise server is configured to provide a third party device with a message indicating that the mobile device is within the boundary defined by the geofence.

13. The mobile device of claim 9, wherein the geofence entry event omits transmission of the location information to the enterprise server.

14. The mobile device of claim 9, wherein the application is further configured to initiate a geofence exit event in response to losing communication with the detected wireless device.

15. The mobile device of claim 14, wherein the geofence exit event comprises:
providing an indication to the enterprise server that the mobile device has exited the geofence; and
setting the update interval.

16. The mobile device of claim 15, wherein the enterprise server is further configured to provide a third party device with a message indicating that the mobile device has exited the boundary defined by the geofence.

17. A non-transitory machine readable medium having machine executable instructions, the machine executable instructions comprising an application configured to determine an update interval that defines an interval of time between queries to a location sensor for updated location information and an interval of time between requests for scans for wireless devices at a wireless interface, wherein the determination is based on a velocity vector of a mobile device and a distance between the mobile device and a location of a wireless device that has an associated geofence.

18. The non-transitory machine readable medium of claim 17, wherein the application comprises an adaptive algorithm configured to determine the update interval.

19. A method comprising:
setting an update interval that defines an interval of time between queries to a location sensor for updated location information and an interval of time between requests for scans for wireless devices at a mobile device, wherein the update interval is based on a velocity vector of the mobile device and a distance between the mobile device and a location of a wireless device that has an associated with a geofence;
initiating a geofence entry event for a geofence in response to identifying a detected wireless device; and
providing an identifier of the wireless device to an enterprise server in response to the initiating.

20. The method of claim 19, further comprising receiving a message from the enterprise server in response to the providing.
